(19) United States
(12) Patent Application Publication
(10) Pub. No.: US 2009/0092185 A1
(43) Pub. Date: Apr. 9, 2009

(54) PORTABLE DEVICE FOR PROCESSING MULTIMEDIA SIGNAL AND METHOD USING THE SAME

(75) Inventors: Tae Soo KWON, Gyeonggi-do (KR); Kyung Hun Jang, Gyeonggi-do (KR); Tae In Hyon, Gyeonggi-do (KR); In Sun Lee, Seoul (KR); Young Soo Kim, Seoul (KR); Hyo Sun Hwang, Seoul (KR); Hyun Gi Ahn, Incheon (KR); Hyun Ho Choi, Gyeonggi-do (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/024,409

(22) Filed: Feb. 1, 2008

(30) Foreign Application Priority Data
Oct. 4, 2007 (KR) 10-2007-0099981

(51) Int. Cl. H04B 1/66

(52) U.S. Cl. 375/240.01

(57) ABSTRACT

A portable device for processing a multimedia signal is provided. The portable device includes: a signal receiver to receive a multimedia signal from a mobile terminal, the multimedia signal being received in the mobile terminal from a service providing server; a decoding-related information generation unit to generate decoding-related information which is related to at least one of a codec and a resolution; a decoder to decode the multimedia signal according to the decoding-related information, and to generate multimedia information; and a multimedia information transmitter to transmit the multimedia information to an external display device.

### CROSS-REFERENCE TO RELATED APPLICATION

This application claims the benefit of Korean Patent Application No. 2007-0099981, filed on Oct. 4, 2007 in the Korean Intellectual Property Office, the disclosure of which is incorporated herein by reference.

### BACKGROUND OF THE INVENTION

1. Field of the Invention

Aspects of the present invention relate to a mobile communication system providing a multimedia service, more particularly, to a portable device for processing a multimedia signal which processes the multimedia signal while being separated from a mobile terminal.

2. Description of the Related Art

Currently, users are provided a multimedia service via a mobile terminal. Specifically, users are provided a video service using a cellular phone having a digital multimedia broadcasting (DMB) receiver installed.

A mobile terminal is required to be light and to be small-sized so that users can easily carry the mobile terminal. In this instance, as the mobile terminal becomes lighter and smaller-sized, sizes of a display device and a battery need to be smaller. However, users require to be provided a multimedia service via a larger display, and at the same time users do not expect an occurrence of a power shortage problem even when they are provided the multimedia service for a relatively long time.

Despite advancements in manufacturing techniques of the mobile terminal or a radio communication technology, there still exists a limitation to manufacture a display device of a mobile terminal larger than a specific size, and there is a problem in that a battery installed in the mobile terminal cannot sustain great power consumption which is required to provide a multimedia service.

It must be noted that, currently, display devices are broadly provided in the market and performance of the display devices are improving. For example, a computer monitor, a television, and the like, are provided to every home, and various display devices are provided in a motor vehicle. In case of the monitor and the television, a size of a display device is generally large, however a power shortage problem rarely occurs. Accordingly, users may be satisfied with a quality of a provided multimedia service when the multimedia service is provided to the user via the display device such as a monitor and a television while the mobile terminal receives a multimedia signal.

Accordingly, there are needs to solve various problems which occur due to a low capacity of a battery or a small-sized display when a multimedia signal received in a mobile terminal is processed, and when a user is provided the multimedia signal in a type of a video or a voice.

### SUMMARY OF THE INVENTION

Aspects of the present invention provide a portable device for processing a multimedia signal and method using the portable device which can improve user satisfaction with respect to a multimedia service since a multimedia signal received in a mobile terminal is decoded and is transmitted to an external display device.

The present invention also provides a portable device for processing a multimedia signal and method using the portable device which can solve a power shortage problem of a mobile terminal since a multimedia signal is decoded using a portable device for processing a multimedia signal, which is separated from the mobile terminal.

The present invention also provides a portable device for processing a multimedia signal and method using the portable device which can utilize various external display devices existing in a periphery of a mobile terminal by performing an appropriate decoding process according to a codec or resolution required by the external display device.

The present invention also provides a portable device for processing a multimedia signal and method using the portable device which can solve a power shortage problem by transmitting a multimedia signal to an external device for processing the multimedia device without decoding the multimedia signal internally.

According to an aspect of the present invention, there is provided a portable device for processing a multimedia signal including: a signal receiver to receive a multimedia signal from a mobile terminal, the multimedia signal being received in the mobile terminal from a service providing server; a decoding-related information generation unit to generate decoding-related information which is related to at least one of a codec and a resolution; a decoder to decode the multimedia signal according to the decoding-related information, and to generate multimedia information; and a multimedia information transmitter to transmit the multimedia information to an external display device.

According to another aspect of the present invention, there is provided a mobile terminal including: a decoding control information generation unit to generate decoding control information by negotiating with a service providing server based on decoding-related information related to at least one of a codec and a resolution which is generated by a portable device for processing a multimedia signal; and a multimedia signal transmitter to transmit a multimedia signal to the portable device for processing the multimedia signal, the multimedia signal being received from the service providing server, wherein the multimedia signal transmitter generates multimedia information by decoding the multimedia signal according to decoding control information, and transmits the multimedia information to an external display device.

According to still another aspect of the present invention, there is provided a method for processing a multimedia signal including: receiving a multimedia signal from a mobile terminal, the multimedia signal being received in the mobile terminal from a service providing server; generating decoding-related information which is related to at least one of a codec and a resolution; decoding the multimedia signal according to the decoding-related information, and generating multimedia information; and transmitting the multimedia information to an external display device.

According to yet another aspect of the present invention, there is provided a method for transmitting a multimedia signal including: generating decoding control information by negotiating with a service providing server based on decoding-related information related to at least one of a codec and a resolution which is generated by a portable device for processing a multimedia signal; and transmitting the multimedia signal, which is received from the service providing server, to the portable device for processing the multimedia signal, the portable device for processing the multimedia signal generating multimedia information by decoding the multimedia signal according to decoding control information, and transmits the multimedia information to an external display device.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a portable device for processing a multimedia signal operated by being connected to an external display device according to an embodiment of the present invention;

FIG. 2 is a block diagram illustrating a portable device for processing a multimedia signal according to an embodiment of the present invention;

FIG. 3 is a block diagram illustrating a mobile terminal device according to an embodiment of the present invention;

FIG. 4 illustrates operations of a service providing server, a mobile terminal, and a portable device for processing a multimedia signal according to an embodiment of the present invention;

FIG. 5 is a flowchart illustrating a method for processing a multimedia signal according to an embodiment of the present invention; and

FIG. 6 is a flowchart illustrating a method for transmitting a multimedia signal according to an embodiment of the present invention.

### DETAILED DESCRIPTION OF EMBODIMENTS

Reference will now be made in detail to present embodiments of the present invention, examples of which are illustrated in the accompanying drawings, wherein like reference numerals refer to the like elements throughout. The exemplary embodiments are described below in order to explain the present invention by referring to the figures.

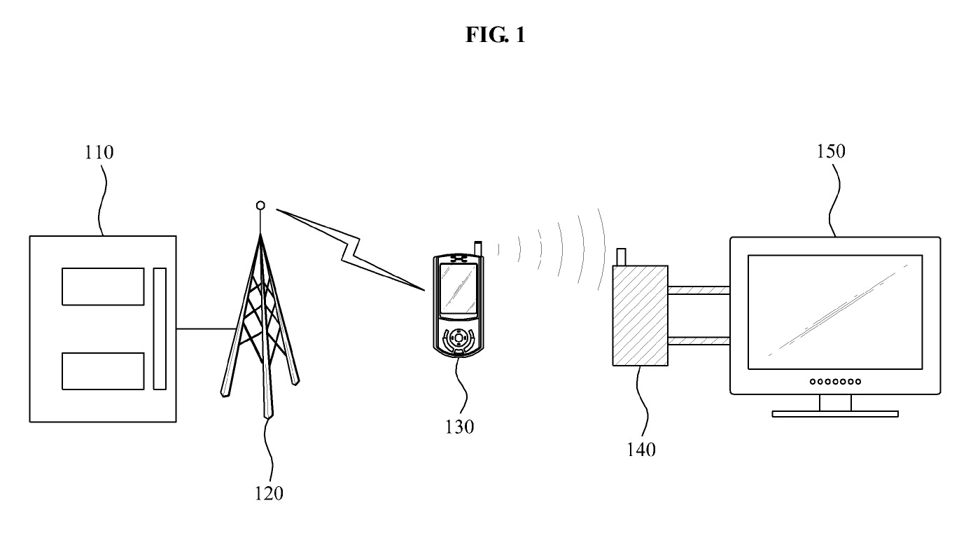

FIG. 1 illustrates a portable device for processing a multimedia signal operated by being connected to an external display device according to an embodiment of the present invention.

Referring to FIG. 1, a service providing server 110, a base station 120, the mobile terminal 130, the portable device 140 for processing a multimedia signal, and the external display device 150 are illustrated in FIG. 1.

The service providing server 110 generates a multimedia signal to provide users with the generated multimedia signal, and transmits the generated multimedia signal to the base station 120. The base station 120 transmits the multimedia signal to users. In this instance, the multimedia signal is generated by encoding multimedia information.

In this instance, the base station 120 may transmit the multimedia signal to users using various methods. For example, the base station may unicast the multimedia signal to a single user, and may multicast/broadcast the multimedia signal to a plurality of users.

The mobile terminal 130 receives the multimedia signal from the base station 120. In this instance, the mobile terminal 130 may be any one of a cellular phone, a notebook computer, a personal data assistant (PDA), and a portable digital multimedia broadcasting (DMB) receiver.

When a user of the mobile terminal 130 needs to be provided with a multimedia service, a decoding process that receives the received multimedia signal to generate multimedia information and a displaying process that displays the multimedia information are required. However, the user may not be provided the multimedia service for a relatively long time since a great amount of power is consumed for the decoding process and the displaying process, and the user may not be satisfied with a quality of the multimedia service since a size of a display of a mobile terminal is not large enough.

According to an embodiment of the present invention, the mobile terminal 130 transmits the received multimedia signal to the portable device 140 for processing the multimedia signal. Also, instead of the mobile terminal 130, the portable device 140 processes and decodes the multimedia signal to generate multimedia information.

Also, the portable device 140 for processing the multimedia signal transmits the generated multimedia information to the external display device 150. Here, the external display device 150 may be any one of a television, a monitor of a computer, and a display device for use in a motor vehicle or a home.

The external display device 150 provides a user with a multimedia service using the received multimedia information. Specifically, instead of the mobile terminal 130, the external display device 150 provides the user with a video service or a voice service.

Consequently, according to an embodiment of the present invention, a power shortage problem of the mobile terminal 130 can be solved since the mobile terminal 130 does not perform the decoding process and the displaying process, and a size and weight of the mobile terminal 130 can be smaller and lighter. Also, user satisfaction can be improved since the multimedia service is provided to a user via the external display device 150 of a larger size.

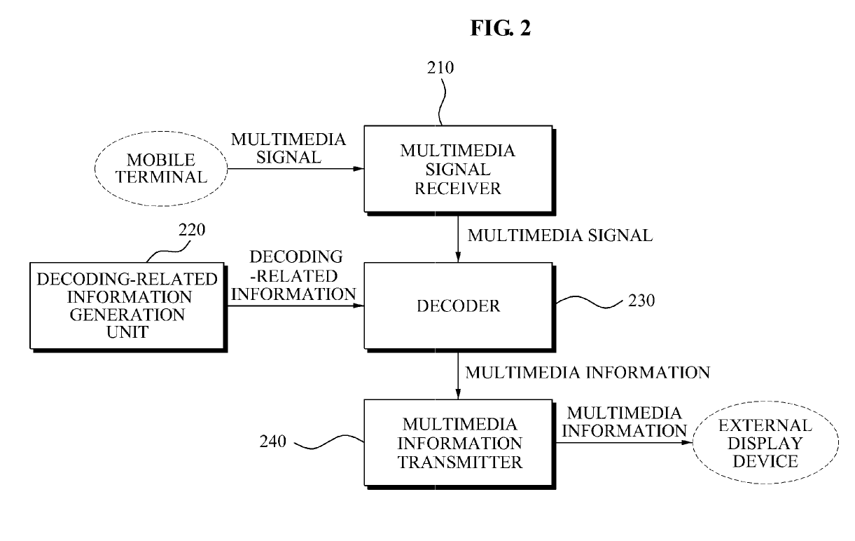

FIG. 2 is a block diagram illustrating a portable device for processing a multimedia signal according to an embodiment of the present invention.

Referring to FIG. 2, the portable device for processing the multimedia signal includes a multimedia signal receiver 210, a decoding-related information generation unit 220, a decoder 230, and a multimedia information transmitter 240.

The multimedia signal receiver 210 receives a multimedia signal from a mobile terminal, the multimedia signal being received in a mobile terminal from a service providing server. That is, the mobile terminal receives the multimedia signal from the service providing server, and transmits the received multimedia signal to the signal receiver 210.

In this instance, the multimedia signal receiver 210 may receive the multimedia signal using various methods. For example, the multimedia signal receiver 210 may receive the multimedia signal using short distance communication technologies including Bluetooth technology, an infrared communication technology, a ZigBee technology, a Wi-Fi fidelity technology, and the like.

In this instance, the multimedia receiver 210 may receive the multimedia signal from the mobile terminal using an available radio resource which is cognitively selected.

Specifically, the mobile terminal or the portable device for processing the multimedia signal may cognitively select the available radio resource including an available spatial resource, frequency resource, and code resource using a cognitive radio technology. The multimedia signal receiver 210 receives the multimedia signal from the mobile terminal via the selected available radio resource, thus, limited radio resources can be effectively utilized.

The decoding-related information generation unit 220 generates decoding-related information which is related to at least one of a codec and a resolution. In this instance, the decoding-related information generation unit 220 may generate the decoding-related information based on a display configuration of the external display device. Specifically, the decoding-related information generation unit 220 generates the decoding-related information by considering at least one of a acceptable resolution and a acceptable codec of the external display device.[see claim 10]

For example, when a acceptable resolution of the external display device is 1024×768, and acceptable codecs of the external display device are A and B codecs, the decoding-related information generation unit 220 generates decoding-related information whose resolution is 1024×768 and which is based on the A and B codecs.

The decoding-related information may be updated into decoding control information via negotiation between the mobile terminal and the service providing server. The decoding-related information is generate by considering the acceptable resolution or the acceptable codec of the external display device, however may be generated without considering characteristics of the multimedia signal generated by the service providing server. In this instance, the mobile terminal and the service providing server may generate the decoding control information, the decoding control information being generated due to updating of the decoding-related information after a negotiation process between the mobile terminal and the service providing server. When there is no need to update the decoding-related information, the decoding-related information and the decoding control information may be identical.

Accordingly, the decoding-related information generation unit 220 may transmit the decoding-related information to the mobile terminal, and the mobile terminal or the service providing server may update the decoding-related information into the decoding control information by processing the negotiation process.

The decoder 230 decodes the multimedia signal according to the decoding-related information to generate multimedia information. That is, since the decoder 230 performs the decoding process instead of the mobile terminal, a power shortage problem of the mobile terminal can be solved.

In this instance, the decoding-related information may include a acceptable resolution or a acceptable codec of the external display device, and the decoder 230 may perform the decoding process according to the decoding-related information.

For example, when a acceptable resolution of the external display device is 1024×768, the decoder 230 may decode the multimedia signal to correspond to the acceptable resolution 1024×768 of the external display device.

In this instance, when the decoding-related information is updated into the decoding control information, the decoder 230 may decode the multimedia signal according to the decoding control information to generate the multimedia information.

Also, the multimedia transmitter 240 transmits the multimedia information to the external display device. In this instance, the external display device provides a user with a multimedia service using the decoded multimedia information.

Since the external display device provides the user with a video service or a voice service instead of the mobile terminal, the user can be provided the multimedia service via a larger sized display, an improved display quality, and an improved voice quality, and a power shortage problem of the mobile terminal 130 can be solved.

Also, although it is not illustrated in FIG. 2, the portable device for processing the multimedia signal may further include a power feeder to feed power to the multimedia signal receiver 210, the decoding-related information generation unit 220, the decoder 230, and the multimedia information transmitter 240. In this instance, the power feeder may provide the portable device for processing the multimedia signal with power which is fed from the external display device.

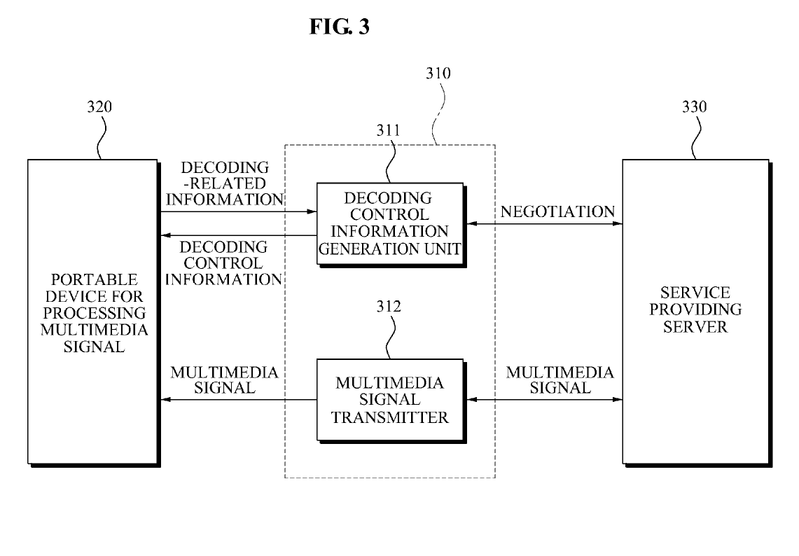

FIG. 3 is a block diagram illustrating a mobile terminal device 310 according to an embodiment of the present invention.

Referring to FIG. 3, the mobile terminal device 310 includes a decoding control information generation unit 311 and a multimedia signal transmitter 312.

The mobile terminal device 310 receives decoding-related information which is related to at least one of a codec and a resolution generated by a portable device 320 for processing a multimedia signal. In this instance, the decoding control information generation unit 311 generates decoding control information by negotiating with a service providing server 330 based on the decoding-related information. That is, the decoding control information generation unit 311 may generate decoding control information, the decoding control information being generated due to updating of the decoding-related information after the negotiation process with the service providing server 330 based on the decoding-related information. In this instance, the decoding control information generation unit 311 transmits the generated decoding control information to the portable device 320 for processing the multimedia signal.

The mobile terminal device 310 receives the multimedia signal from the service providing server 330. In this instance, the multimedia signal transmitter 312 transmits the received multimedia signal to the portable device 320 for processing the multimedia signal.

Specifically, the multimedia signal transmitter 312 may select an available radio resource using a cognitive radio technology, and transmit the multimedia signal to the portable device 320 for processing the multimedia signal using the selected available radio resource.

In this instance, the portable device 320 for processing the multimedia signal decodes the received multimedia signal according to the decoding control information. In this instance, since the multimedia signal is decoded, multimedia information may be generated, and the portable device 320 for processing the multimedia signal may transmit the generated multimedia information to the external display device.

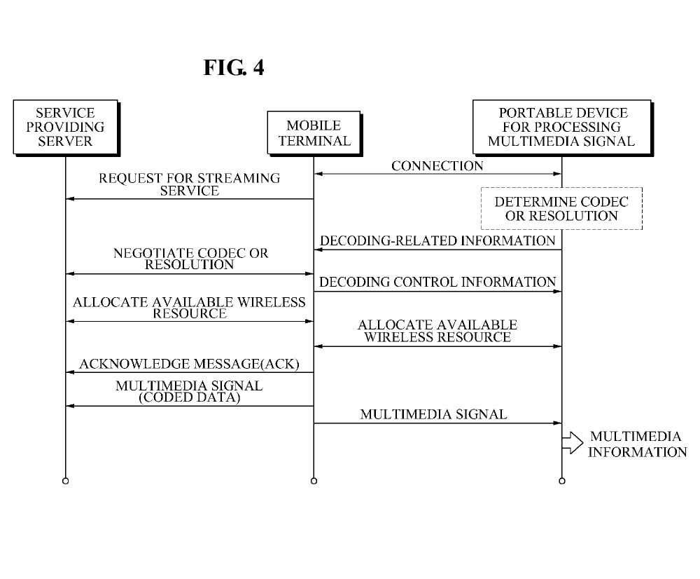

FIG. 4 illustrates operations of a service providing server, a mobile terminal, and a portable device for processing a multimedia signal according to an embodiment of the present invention.

Referring to FIG. 4, the mobile terminal and the portable device for processing the multimedia signal performs a connection with each other.

When performing the connection or immediately after the connection is performed, the portable device for processing the multimedia signal determines a codec or a resolution by considering a acceptable codec or a acceptable resolution of an external display device. Then, the portable device for processing the multimedia signal transmits decoding-related information which is related to the determined codec or resolution to the mobile terminal.

The mobile terminal requests a service providing server for a streaming service, and performs negotiation with the service providing server with respect to the determined codec or resolution by using the received decoding-related information.

When the negotiation is terminated, decoding control information is generated, the decoding control information being generated due to updating of the decoding-related information. Since the decoding-related information is not always updated, but is updated depending on a state of the service providing server and the mobile terminal, the decoding control information may be identical to the decoding-related information in the case that the decoding-related information is not updated.

In this instance, the mobile terminal transmits the decoding control information to the portable device for processing the multimedia signal.

Also, a cognitive radio technology may be utilized for communication between the service providing server and the mobile communication terminal. That is, the service providing server and the mobile communication terminal may transmit/receive data using an allocated available radio resource, that is using the cognitive radio technology.

When the mobile terminal is ready to receive the multimedia signal, the mobile terminal transmits an acknowledge message to the service providing server. In this instance, the service providing server transmits the encoded multimedia signal to the mobile terminal, and the mobile terminal transmits the multimedia signal to the portable device for processing the multimedia signal.

The portable device for processing the multimedia signal decodes the multimedia signal according to the decoding control information to generate multimedia information. Although it is not illustrated in FIG. 4, the multimedia information is transmitted to the external display device.

Thus, when the multimedia information is video information, a user may view the video via the external display device.

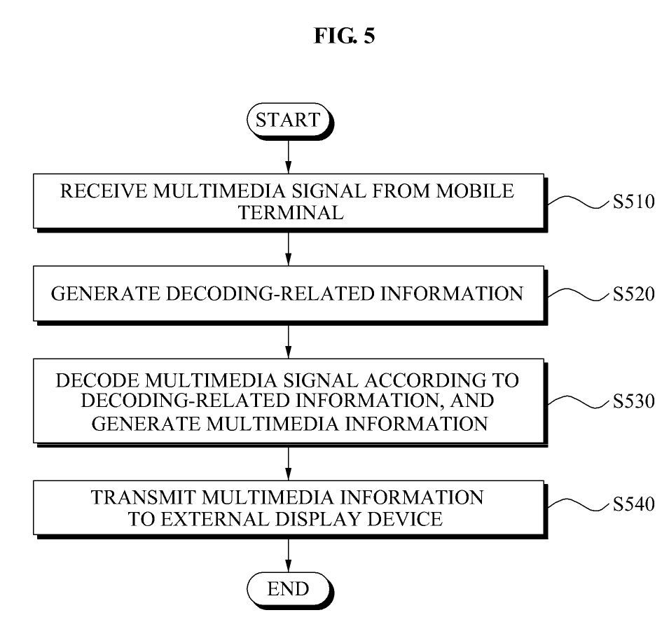

FIG. 5 is a flowchart illustrating a method for processing a multimedia signal according to an embodiment of the present invention.

Referring to FIG. 5, the method for processing the multimedia signal according to the embodiment of the present invention receives a multimedia signal from a mobile terminal, the multimedia signal being received in the mobile terminal from a service providing server, in operation S510.

In this instance, operation S510 may receive the multimedia signal using an available radio resource which is cognitively selected.

In operation S520, the method for processing the multimedia signal according to the embodiment of the present invention generates decoding-related information which is related to at least one of a codec and a resolution.

In this instance, in operation S520, the decoding-related information may be generated by considering at least one of a acceptable resolution and a acceptable codec of an external display device.

In operation S530, the method for processing the multimedia signal according to the embodiment of the present invention decodes the multimedia signal according to the decoding-related information to generate multimedia information.

In operation S520, the decoding-related information is transmitted to the mobile terminal, and any one of the mobile terminal or a service providing server receives decoding control information, which is generated due to updating of the decoding-related information by any one of the mobile terminal or the service providing server. In operation S530, the multimedia signal is decoded according to the decoding control information to generate the multimedia information.

In operation S540, the method for processing the multimedia signal according to the embodiment of the present invention transmits the multimedia information to the external display device.

Although it is not illustrated in FIG. 5, the method for processing the multimedia signal according to the embodiment of the present invention may further include an operation of feeding power, the power being fed from the external display device.

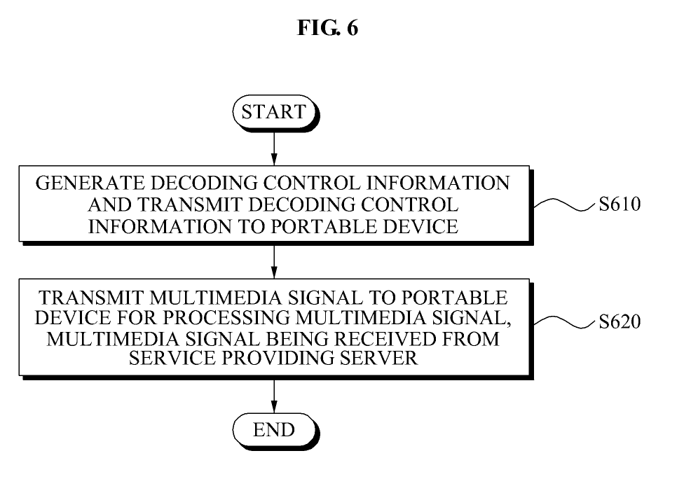

FIG. 6 is a flowchart illustrating a method for transmitting a multimedia signal according to an embodiment of the present invention.

In operation S610, the method for transmitting the multimedia signal according to the embodiment of the present invention generates decoding control information by negotiating with a service providing server based on decoding-related information related to at least one of a codec and a resolution which is generated by a portable device for processing a multimedia signal, and transmits the decoding control information to the portable device for processing the multimedia signal.

In operation S620, the method for transmitting the multimedia signal according to the embodiment of the present invention transmits the multimedia signal to the portable device for processing the multimedia signal, the multimedia signal being received from the service providing server.

In this instance, the portable device for processing the multimedia signal decodes the multimedia signal according to the decoding control information to generate multimedia information, and transmits the multimedia information to an external display device.

The method for processing and transmitting the multimedia signal according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

According to the present invention, it is possible to improve user satisfaction with respect to a multimedia service since a multimedia signal received in a mobile terminal is decoded and is transmitted to an external display device.

Also, according to the present invention, it is possible to can solve a power shortage problem of a mobile terminal since a multimedia signal is decoded using a portable device for processing a multimedia signal, which is separated from the mobile terminal.

Also, according to the present invention, it is possible to utilize various external display devices existing in a periphery of a mobile terminal by performing an appropriate decoding process according to a codec or resolution required by the external display device.

Also, according to the present invention, it is possible to solve a power shortage problem by transmitting a multimedia signal to an external device for processing the multimedia device without decoding the multimedia signal internally.

Although a few embodiments of the present invention have been shown and described, it would be appreciated by those skilled in the art that changes may be made to these embodiments without departing from the principles and spirit of the invention, the scope of which is defined by the claims and their equivalents.

What is claimed is:

1. A portable device for processing a multimedia signal, comprising:
a signal receiver to receive a multimedia signal from a mobile terminal, the multimedia signal being received in the mobile terminal from a service providing server;
a decoding-related information generation unit to generate decoding-related information which is related to at least one of a codec and a resolution;
a decoder to decode the multimedia signal according to the decoding-related information, and to generate multimedia information; and
a multimedia information transmitter to transmit the multimedia information to an external display device.

2. The portable device of claim 1, wherein the decoding-related information generation unit transmits the decoding-related information to the mobile terminal, and receives decoding control information from the mobile terminal, the decoding control information being generated due to updating of the decoding-related information by any one of the mobile terminal and the service providing server, and the decoder generates the multimedia information by decoding the multimedia signal according to the decoding control information.

3. The portable device of claim 1, wherein the decoding-related information generation unit generates the decoding-related information based on a display configuration of the external display device.

4. The portable device of claim 1, wherein the decoding-related information generation unit generates the decoding-related information by considering at least one of a acceptable resolution and a acceptable codec of the external display device.

5. The portable device of claim 1, wherein the signal receiver receives the multimedia signal using an available radio resource which is cognitively selected.

6. The portable device of claim 1, further comprising:
a power feeder to feed power to the multimedia signal receiver, the decoding-related information generation unit, the decoder, and the multimedia information transmitter.

7. The portable device of claim 6, wherein the power feeder feeds power from the external display device.

8. The portable device for processing of the multimedia signal of claim 1, wherein the mobile terminal is any one of a cellular phone, a notebook computer, a personal data assistant (PDA), and a portable digital multimedia broadcasting (DMB) receiver, and the external display device is any one of a television, a computer monitor, and a display device for use in a motor vehicle or a home.

9. A mobile terminal comprising:
a decoding control information generation unit to generate decoding control information by negotiating with a service providing server based on decoding-related information related to at least one of a codec and a resolution which is generated by a portable device for processing a multimedia signal; and
a multimedia signal transmitter to transmit a multimedia signal to the portable device for processing the multimedia signal, the multimedia signal being received from the service providing server,
wherein the multimedia signal transmitter generates multimedia information by decoding the multimedia signal according to decoding control information, and transmits the multimedia information to an external display device.

10. The mobile terminal of claim 9, wherein the decoding-related information is generated from the portable device for processing the multimedia signal based on at least one of a acceptable resolution and a acceptable codec of the external display device.

11. The mobile terminal of claim 9, wherein the multimedia signal transmitter cognitively selects an available radio resource, and transmits the multimedia signal using the selected available radio resource.

12. A method for processing a multimedia signal, comprising:
receiving a multimedia signal from a mobile terminal, the multimedia signal being received in the mobile terminal from a service providing server;
generating decoding-related information which is related to at least one of a codec and a resolution;
decoding the multimedia signal according to the decoding-related information, and generating multimedia information; and
transmitting the multimedia information to an external display device.

13. The method of claim 12, wherein the generating of the decoding-related information transmits the decoding-related information to the mobile terminal, and receives decoding control information from the mobile terminal, the decoding control information being generated due to updating of the decoding-related information by any one of the mobile terminal and the service providing server, and the generating of the multimedia information generates the multimedia information by decoding the multimedia signal according to the decoding control information.

14. The method of claim 12, wherein the generating of the decoding-related information generates the decoding-related information by considering at least one of a acceptable resolution and a acceptable codec of the external display device.

15. The method of claim 12, wherein the receiving of the multimedia signal from the mobile terminal receives the multimedia signal using an available radio resource which is cognitively selected.

16. The method of claim 12, further comprising:
feeding power being fed from the external display device.

17. A method for transmitting a multimedia signal, comprising:
generating decoding control information by negotiating with a service providing server based on decoding-related information related to at least one of a codec and a resolution which is generated by a portable device for processing a multimedia signal; and
transmitting the multimedia signal, which is received from the service providing server, to the portable device for processing the multimedia signal, the portable device for processing the multimedia signal generating multimedia information by decoding the multimedia signal according to decoding control information, and transmits the multimedia information to an external display device.

18. The method for transmitting the multimedia signal of claim 17, wherein the decoding-related information is generated from the portable device for processing the multimedia signal by considering at least one of a acceptable resolution and a acceptable codec of the external display device.

19. The method for transmitting the multimedia signal of claim 17, wherein the transmitting of the multimedia signal cognitively selects an available radio resource, and transmits the multimedia signal using the selected available radio resource.

20. At least one computer-readable storage medium storing instructions for implementing the method of claim 12.

21. At least one computer-readable storage medium storing instructions for implementing the method of claim 17.
